(19) United States
(12) Patent Application Publication
(10) Pub. No.: US 2010/0260939 A1
(43) Pub. Date: Oct. 14, 2010

(54) INK-JET MEDIA HAVING SUPPORTING INTERMEDIATE COATINGS AND MICROPOROUS TOP COATINGS

(75) Inventor: James A. Foley, Wellesley, MA (US)

Correspondence Address: BARLOW, JOSEPHS & HOLMES, LTD., 101 DYER STREET, 5TH FLOOR, PROVIDENCE, RI, 02903, US

(73) Assignee: ARKWRIGHT ADVANCED COATING, INC., Chesapeake, VA (US)

(21) Appl. No.: 12/824,218

(22) Filed: Jun. 27, 2010

Related U.S. Application Data
(62) Division of application No. 11/326,664, filed on Jan. 6, 2006.
(60) Provisional application No. 60/641,698, filed on Jan. 6, 2005.

(51) Int. Cl. B05D 3/02

(52) U.S. Cl. 427/385.5

(57) ABSTRACT

An ink-jet printable medium includes a substrate having an imaging surface with a supporting intermediate coating overlying the imaging surface and a microporous ink-receptive coating overlying the supporting intermediate coating.

### CROSS-REFERENCE TO RELATED APPLICATION

The present application is a divisional application of U.S. Non-Provisional application Ser. No. 11/326,664 filed Jan. 6, 2006, and claims the benefit of the priority date of U.S. Provisional Patent Application 60/641,698 filed on Jan. 6, 2005, all of which are incorporated herein by reference.

### BACKGROUND OF THE INVENTION

Modern ink jet printing systems produce colored images on papers, films, and other imaging media that can be used in many different applications. The printed media can be used as indoor and outdoor signage, posters, bulletins, advertising banners, and the like to provide colorful graphic displays. The ink-jet printing systems employ various digital technologies, inks, and ink-jet printers to produce high quality printed images on the imaging media.

In a typical ink-jet printing process, liquid ink is squirted through very fine nozzles of a printer onto the imaging medium. This results in a printed image being formed on the surface of the imaging medium. Many inks used in ink jet printing devices are aqueous-based inks containing water as their primary component. The aqueous-based inks contain molecular dyes or pigmented colorants. Small amounts of water-miscible solvents, such as glycols and glycol ethers, may be present.

The substrate of the ink jet imaging medium is to be printed thereon, can be selected from a wide variety of materials such as papers, films, non-woven webs, metal foils, and the like. The medium substrate typically is coated with one or more layers of specially designed compositions that make the medium capable of receiving and holding the aqueous-based inks effectively so as to generate a printed image. Despite the progress to date, there is a need for coated media having superior print performance properties and for media that can be produced in more economic ways.

In recent years, the ink jet industry has attempted to address the need for imaging media having improved print properties by developing ink-receptive coatings that commonly are referred to as “porous” or “microporous” ink-receptive coatings. These porous or microporous ink-receptive layers contain particles and polymer binders. The particle and polymer binder materials, in combination, provide the ink-receptive layer with a porous or microporous morphology that can better absorb aqueous inks. The particles form interstitial pores or voids in the ink-receptive layer so that the layer can absorb the ink in part by a wicking or capillary action. As ink is impinged onto the layer, it enters these interstitial voids and is absorbed effectively.

Manufacturers of ink-jet recording media having a microporous ink-receptive coating must address several issues during the manufacturing process. Microporous coatings having a relatively high void volume are desirable because these coatings could have a relatively low cost if they could be manufactured inexpensively. The weight of such a coating would be relatively low, and the coating might not contain a large amount of costly components. However, there is a major drawback in the manufacture of such microporous coatings. When manufactured with conventional ovens at economic drying speeds, splits and cracks can form in the coating as the microporous coating is dried in the ovens or other equipment. In some instances, these defects can be overcome by lowering the drying temperature of the ovens and slowing the speed of the coating line, but these changes to the manufacturing process lead to higher manufacturing costs. Using special, very long drying ovens that typically employ low drying rates can lead to good products, but manufacturing costs in that case are driven up by the need for major capital investments and increased maintenance and operating costs. Splits are defined as large defects, often 1-10 mm wide and 5-20 mm long (or longer), and their presence makes the product unusable. Cracks are smaller defects, typically on the micron scale, and develop from point defects in the film. These defects are related, but tend to occur in two different parts of the drying cycle. The drying cycle is composed of at least four distinct processing regions; predryer, constant rate (substantially constant evaporation rate), falling rate (falling evaporation rate) and equillibration. Most drying occurs in the constant rate and falling rate portions of the cycle. Splits in the microporous coating are analogous to “mud cracking” and are seen in the beginning or just before the beginning of the falling rate point in the drying cycle. Cracks in the microporous coating tend to occur later, particularly towards the end of the falling rate or during the bake portion (equilibration portion) of the drying cycle.

Accordingly, there is a pressing need for improved inkjet imaging media that have excellent properties and that can be manufactured economically by addressing the foregoing problems. The ink-receptive coated layer should have good mechanical integrity and be generally flexible so that cracks do not form in the layer during handling, packaging, or printing of the media or in any end-use applications of the printed media. The ink jet media should also be capable of generating high-quality images and have fast ink drying times and good water-resistance.

The present invention provides ink jet imaging media having such improved mechanical and print performance properties.

### SUMMARY OF THE INVENTION

The present invention solves the problems of the prior art by providing an ink jet printable medium that includes a substrate having an imaging surface with a stable absorptive and supporting intermediate coating (intercoat) overlying the imaging surface and a microporous ink-receptive coating overlying the intercoat.

One aspect of the invention thus is a printing medium with a coating structure, and a process for making that structure, which structure consists at least of a substrate, at least one intermediate coating on one surface of the substrate, and at least one image receptive topcoat over the intercoat. The intercoat of the medium provides a stable and absorptive underlying base so that the microporous topcoat can be applied over the intercoat and dried to produce a high quality medium in an economical manner.

The intermediate coating (intercoat) can comprise one or more constituents that can provide beneficial mechanical properties and one or more ink-vehicle absorptive materials. In one preferred embodiment, the materials providing the beneficial mechanical properties are polymers. In another, one or more particulates and one or more polymers are used. In a more preferred embodiment, the polymers are two acrylic polymers; one with a glass transition, Tg, below the normal use temperature range, and the other with a Tg above this range. In a most preferred embodiment, the higher Tg is also above the process drying temperature. In these embodiments, the ink-vehicle absorptive material is a water absorptive polymer, such as poly(vinylpyrrolidone) (PVP), PEOX, polyvinyl alcohol (PVA), or an alkylcellulose, such as methyl cellulose (methocel).

Other preferred embodiments can be formulated in accordance with the teachings of the invention. Thus, in another preferred embodiment, the intercoat can comprise constituents that can combine beneficially with the microporous topcoat selected for the medium. When the topcoat comprises polymers, such as PVA, that can interact beneficially with borates, the intercoat preferably can comprise borates.

Other embodiments of the invention consist of analogous constituents selected for media in which the ink-vehicle is a liquid other than water. For example, the ink vehicle may be any vehicle that is liquid during the application of the ink to create the image. When the ink-vehicle or the coating vehicle is not water, the absorbants are selected for these vehicles.

The resulting ink jet imaging medium produced in accordance with this invention has many desirable properties. The ink jet imaging medium of this invention offers several improvements over conventional ink-jet media. First, the porous ink-receptive layer can have a lower coat weight, because the intercoat layer has ink-vehicle absorbing properties. Secondly, the topcoat may have a higher pigment to binder mass ratio because less film-forming binder is needed in the top coat to form a stable topcoat film when it is coated and dried over the intercoat of this invention. Thirdly, although there is an increase in the pigment to binder mass ratio of the top coat, the ink jet media of this invention can be manufactured at a faster coating line speed and higher temperature drying conditions than an analogous medium without this intercoat. Thus, the manufacturing process used to make the inkjet media of this invention is both robust and cost-effective.

Other advantages of the intercoat layer includes the controlled swelling and wet strength of this layer. The wet strength of the intercoat layer means that the highly pigmented microporous layer can be coated effectively over this intercoat layer. This combination of coatings provides a final coated medium having a strong and durable coating that is less likely to crack under stresses.

Also, the media of this invention have improved ink-drying times over conventional media. The ink jet imaging medium has good water-resistance so that the printed image is less likely to smear or rub-off after the image is wetted. The ink-jet medium can produce high quality printed images having high color brilliance, sharpness, and fidelity.

### BRIEF DESCRIPTION OF THE DRAWING

These and other features, aspects, and advantages of the present invention will become better understood with reference to the following description, appended claims, and accompanying drawings where:

FIG. 1 is a schematic side view of one embodiment of the ink jet imaging medium of the present invention.

### DETAILED DESCRIPTION OF THE PREFERRED EMBODIMENTS

### Substrate

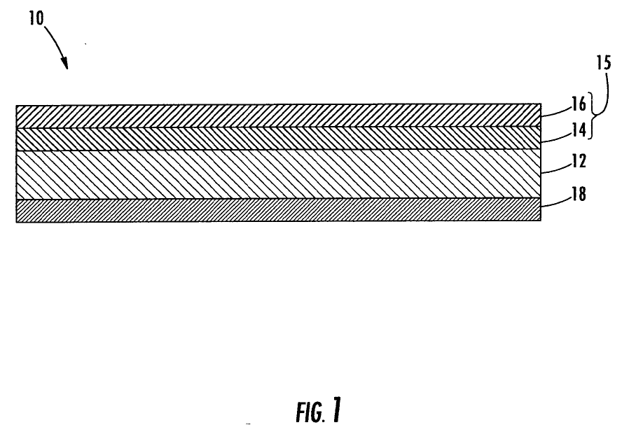

Referring to FIG. 1, a preferred embodiment of the ink jet recording media is shown graphically at 10. The ink-jet recording media 10 of the present invention are constructed using a suitable substrate material 12. For example, the substrate material 12 may be a paper material. Paper substrates 12 are known in the ink jet industry and any suitable paper may be used in the present invention. For example, plain papers, clay-coated papers, or resin-coated papers may be used. The base weight of the paper is typically in the range of about 70 to about 260 grams per square meter (gsm). The thickness of the paper is typically in the range of about 3 mils to about 10 mils. The paper substrate 12 may be pre-treated with conventional adhesion promoters to enhance adhesion of the coatings to the paper. In other embodiments, the paper substrate 12 may be coated with a primer or moisture barrier layer. For example, a radiation-curable barrier coating may be applied to the substrate 12 and subsequently cured with UV light or electron beam irradiation. It is also recognized that the paper substrate 12 can have different surface finishes. For example, glossy paper substrates can be used. In other embodiments, satin-like or semi-glossy substrates can be used. In still other embodiments, matte-like substrates can be used.

Alternatively, the substrate 12 may be a polymeric film comprising a polymer such as, for example, polyethylene, polypropylene, polyester, naphthalate, polycarbonates, polysulfone, polyether sulfone, poly(arylene sulfone), cellulose triacetate, cellophane, polyvinyl chloride, polyvinyl fluoride, polyimides, polystyrene, polyacrylics, polyacetals, ionomers, and mixtures thereof. In other instances, a metal foil such as aluminum foil or a metal-coated material can be used as the substrate 12.

The substrate 12 material has two surfaces. The first surface, which is coated with the ink-receptive layers in accordance with this invention, may be referred to as the “front” or “imaging” surface. The second surface, which is opposite to the first surface, may be referred to as the “back” or “non-imaging” surface.

### Supporting Underlayer (Intermediate Coating) (Intercoat)

In the present invention, the imaging surface of the substrate 12 is coated first with at least one supporting underlayer or intermediate coating 14 (intercoat). One function of the intercoat 14 is to provide a strong, stable and ink-vehicle absorptive support layer for the ink-receptive microporous topcoat 16, which is applied over the intercoat 14.

The intercoat 14 may be applied to the substrate as a wet coating and subsequently dried in a first drying cycle. Then, the top coat 16 is applied, preferably as a wet coating, over the intercoat 14 and the fully coated medium is dried in a second drying cycle. The intercoat 14 and top coat 16 formulations may be applied to the substrate using conventional coating methods such as, for example, Meyer-rod, roller, blade, wire bar, dip, solution extrusion, air-knife, curtain, slide, doctor-knife, and gravure methods. Alternatively, application of the intercoat may be done by lamination or other suitable means known in the art. The coating formulations are dried using conventional techniques such as forced hot air ovens or dryers.

Although not wishing to be bound by any particular mechanistic interpretation, it is believed to be important that the intercoat 14 has good mechanical integrity and the capability to absorb moisture from the top coat 16 during the second drying cycle. The coated web 15 is susceptible to splitting during the initial phase of the second drying cycle when forcing conditions are used. It is believed that the intercoat 14 of this invention prevents splits from generating in the coated web by increasing the wet strength of the web coating 15. In this interpretation, the intercoat 14 absorbs some water (i.e., “dewaters”) the top coat 16 as the coated web 15 enters the dryer. Particularly, the intercoat 14 absorbs moisture from the top coat 16 while moisture is being removed by drying from the top surface of the coated web 15. This controlled dewatering step improves the wet strength of the top coat 16 so that the coated web 15 can withstand the stresses imparted thereon during this drying step. This results in minimal or no splits forming in the topcoat 16.

Furthermore, it is important that the intercoat 14 be stable at the higher temperatures of the coated web 15 during the later phase of the second drying cycle. Cracks may propagate in the coated web 15 during this phase of the drying cycle. It is believed that the intercoat 14 prevents cracks from forming in the coated web 15 at this point, because the intercoat 14 has high stability and also may mechanically bond to the top coat 16, thereby forming a reinforced coated web 15 having high mechanical integrity.

The intercoat 14 of this invention may be prepared from a coating formulation comprising a blend of at least one acrylic copolymer and poly(vinyl pyrrolidone) (PVP), poly(2-ethyl-2-oxazoline) (PEOX), a poly(vinyl alcohol) (PVA), and/or an alkylcellulose, such as methocel. The acrylic copolymer, PVP, PVA, methocel and PEOX are film-forming materials. The acrylic copolymer may be selected from such polymers as, for example, styrene acrylics (available under the tradenames of Joncryl 624 and Joncryl HPD-71 from Johnson Polymers). In one embodiment, a blend comprising an acrylic copolymer having a relatively low Tg and PVP is used. Particularly, a blend comprising an acrylic copolymer having a Tg of less than 25° C., and PVP can be used. For example, the acrylic copolymer, Joncryl 624 has a relatively low glass transition temperature (Tg) of about −30° C. The acrylic copolymer is typically present in the intercoat in an amount of about 60% to about 90%, and the PVP is present in an amount of about 10% to about 40% based on dry weight of the intercoat. It has been found that the combination of the Joncryl 624 material and the PVP provides a stable and absorptive intercoat that effectively supports the top coat. This results in a coated media product 10 that does not develop splits during the drying process.

In another embodiment of the intercoat 14, a blend comprising an acrylic copolymer having a relatively low Tg; an acrylic copolymer having a relatively high Tg; and PVP is used. For example, an acrylic copolymer having a Tg of less than 25° C. may be used in combination with an acrylic copolymer having a Tg of greater than 25° C. The acrylic copolymer having the relatively low Tg typically is present in the intercoat in an amount of about 20% to about 60%, the acrylic copolymer having the relatively high Tg typically is present in the intercoat in the amount of about 10% to about 40%, and the PVP typically is present in the intercoat in the amount of about 20% to about 40% based on dry weight of the intercoat layer 14. The acrylic copolymer, Joncryl HPD-71 has a Tg of about 128° C. It has been found that the combination of the Joncryl 624 and Joncryl HPD-71 materials and the PVP provides a stable intercoat 14 having good mechanical properties at high drying temperatures. The intercoat 14 has good thermal stability. This results in a coated media product 10 that does not develop unacceptable levels of cracking during the drying process.

In addition, it has been found that an acrylic copolymer or blend of acrylic copolymers having a relatively high acid functionality, e.g. acid number, also provides the coating with additional beneficial properties. For example, it may be desirable to use an acrylic copolymer having an acid functionality of at least 25. The Joncryl 624 material has an acid number of 50, and the Joncryl HPD-71 material has an acid number of 214. It is believed that acrylic copolymers having a high acid functionality provide the coating with useful ink-vehicle absorptivity. The moisture sensitivity of the coating may be controlled and enhanced by using these high acid acrylic copolymers in combination with the absorptive material in the intercoat, such as PVP.

Alternatively, the intercoat 14 may be prepared from a coating formulation comprising a blend of at least two polymeric materials and an absorbing polymer where at least one of the polymeric materials has a Tg less than 25 degrees Celcius and at least one polymeric materials has a Tg greater than 25 degrees Celcius and the absorptive material is selected from a group consisting of poly(vinyl pyrrolidone) (PVP), poly(2-ethyl-2-oxazoline) (PEOX), a poly(vinyl alcohol) (PVA), and/or an alkylcellulose, such as methocel.

The intercoat 14 also may contain functional additives such as inhibitors, surfactants, waxes, plasticizers, cross-linking agents, dye fixatives, de-foaming agents, pigments, dispersing agents, optical brighteners, UV light stabilizers (blockers), UV absorbers, adhesion promoters, and the like. In particular, it has been found that borate salts (sodium tetraborate decahydrate and/or potassium tetraborate decahydrate) (generally known as Borax), may be may be added as a cross-linking agent to the coating formulation for the intercoat. It is believed that borate salts, such as the Borax material, will gel with certain of the binders that are used in the topcoat, such as poly(vinyl alcohol) or polysaccharide material in the top coat. If borate salts are added to the intercoat 14, they should be added in a relatively small amount (typically 0.05 gsm to 1 gsm). This amount may be adjusted to account for changes in the topcoat binder.

It also is recognized that the intercoat 14 of this invention may have good ink-receiving properties. In other words, the intercoat 14 may be capable of absorbing pigmented and dye-based inks from ink jet printers to form a printed image.

### Microporous Ink-Receptive Layer (Topcoat)

A microporous ink-receptive layer 16 is applied over the supporting intercoat layer 14. The porous ink-receptive layer 16 contains particles and a polymer binder. These particle and polymer binder materials provide the ink-receptive layer 16 with a porous morphology. This porous structure enables the ink-receptive layer 16 to better absorb the aqueous ink vehicle (water). The particles form interstitial pores or voids in the ink-receptive layer 16 so that the layer can absorb the liquid by a wicking or capillary action as well as by polymers and other absorptive components. As ink is impinged onto the layer 16, it enters these interstitial voids and is absorbed effectively. The blend of particles and polymer binders in the ink-receptive layer 16 contributes to the relatively fast ink-drying times of the media.

Suitable inorganic particles that can be used in the ink-receptive layer 16 include, for example, those selected from the group consisting of kaolin, talc, clay, calcium sulfate, calcium carbonate, alumina, aluminum silicate, colloidal alumina, silica, silica-alumina, alumina coated silica, colloidal silica, lithopone, zeolite, hydrated halloysite, magnesium hydroxide, magnesium carbonate, barium sulfate, titanium dioxide, zinc oxide, zinc sulfate, and zinc carbonate particles. Suitable organic polymer particles include, for example, those selected from the group consisting of polyethylene, polypropylene, polyacrylate, polymethacrylate, polystyrene, fluoropolymer, and polyester particles. The particles, themselves, can have a high surface area and porous structure. Such porous particles can absorb the aqueous ink vehicle themselves in addition to forming voids in the ink-receptive layer.

In the present invention, the ink-receptive layer 16 may contain 40% to 96% particles by weight based on dry weight of the ink-receptive layer 16. Preferably, it contains 80%-96% by weight.

The binder resin used in the porous ink-receptive layer 16 provides cohesion and mechanical integrity to the porous ink-receptive layer 16. The binders typically are water-soluble or water-dispersible, especially when the ultimate application is aqueous-based ink jet printing, and include, for example, those selected from the group consisting of polyvinyl alcohols (PVAs); modified polyvinyl alcohols (e.g., carboxyl-modified PVA, silicone-modified PVA, maleic acid-modified PVA, and itaconic acid-modified PVA); polysaccharides; polyurethane dispersions; acrylic copolymers; vinyl acetate copolymers; poly(vinyl pyrrolidone); vinyl pyrrolidone copolymers; poly(2-ethyl-2-oxazoline); poly(ethylene oxide); poly(ethylene glycol); poly(acrylic acids); starch; modified starch (e.g., oxidized starch, cationic starch, hydroxypropyl starch, and hydroxyethyl starch), cellulosic polymers oxidized cellulose, cellulose ethers, cellulose esters, methyl cellulose, hydroxyethyl cellulose, carboxymethyl-cellulose, benzyl cellulose, phenyl cellulose, hydroxypropyl cellulose, ethyl hydroxyethyl cellulose, hydroxyethyl methyl cellulose, hydroxypropyl methyl cellulose, hydroxy butylmethyl cellulose, dihydroxypropyl cellulose, hydroxypropyl hydroxyethyl cellulose, chlorodeoxycellulose, aminodeoxycellulose, diethylammonium chloride hydroxyethyl cellulose, and hydroxypropyl trimethyl ammonium chloride hydroxyethyl cellulose); alginates and water-soluble gums; dextrans; carrageenan; xanthan; chitosan; proteins; gelatins; agar; and mixtures thereof.

In addition, the porous ink-receptive layer 16 may contain additives such as pigments for coloration, surface active agents to influence the wetting or spreading action of the coating as it is applied to the substrate, anti-static agents, suspending agents, compounds to control the pH of the coating, optical brighteners, de-foamers, humectants, waxes, plasticizers, and the like.

The above-described conventional coating methods, for example, Meyer-rod coating methods, which may used to apply the intercoat layer, also may be used to apply the porous ink-receptive layer 16 in accordance with this invention.

### Coating of Back Surface of Substrate

In addition, the back surface of the base substrate 12 may be coated with a polymeric layer 18 that further helps prevent moisture from penetrating into the base substrate 12. The polymeric coating 18 on the back surface of the substrate 12 enhances the substrate's 12 dimensional stability and helps minimize substrate curling, cockling, and other defects. The back coating 18 also provides surface-friction to assist feeding of the imaging medium 10 into an ink jet printer. The back coating 18 typically also provides anti-static properties to the ink jet imaging medium 10.

### Advantageous Properties of the Ink-Jet Recording Medium

The resulting ink jet imaging medium 10 produced in accordance with this invention offers several improvements over conventional ink-jet media. First, the use of a stable and absorptive intercoat makes it feasible to produce a high quality medium with a microporous topcoat (ink-receiving layer) using drying conditions that provide a significant economic advantage. This advantage arises because the relatively high temperature and high air flow conditions of a short, high speed oven can be used, and this is less expensive than using a slow drying processes in long expensive ovens using less forcing conditions to achieve the same drying. Second, the stability of the intercoat of this invention reduces the mechanical requirements on the topcoat and this permits the use of higher pigment to binder mass ratio than would be needed otherwise. That, in turn, makes it possible to achieve the needed ink vehicle absorptivity with lower coat weight than would be required otherwise. Third, the absorbance capacity of the intercoat further reduces the absorbance capacity requirement of the topcoat. The manufacturing process used to make the ink-jet media 10 of this invention is robust and cost-effective.

Other advantages of the intercoat layer 14 includes the controlled swelling and wet strength of this layer 14. The wet strength of the intercoat layer means 14 that the highly pigmented microporous layer 16 can be coated effectively over this intercoat layer 14. This combination of coatings provides a final coated medium 10 having a strong and durable coating that is less likely to crack under stresses.

Also, the media 10 of this invention have improved ink-drying times over conventional media. The ink jet imaging medium 10 has good water-resistance so that the printed image is less likely to smear or rub-off after the image is wetted. The ink-jet medium 10 can produce high quality printed images having high color brilliance, sharpness, and fidelity.

### Examples

Some examples of the ink jet imaging media 10 of this invention are illustrated below. These examples should not be construed as limiting the scope of the invention. In the following examples, percentages are by weight based on the weight of the finished dry coating, unless otherwise indicated.

### Intercoat Formulations

Intercoat 14 formulations were prepared at 10%-20% solids in water to have the final dry coating material compositions listed. The coating then were were applied over a clay coated paper or a polyester (PET) substrate, as designated, using a Meyer-rod. The substrate coated with the intercoat layer 14 was dried in a convection oven for 3 minutes at 100° C.

### Examples of Intercoats of the Invention

### Example 1

| | | | % Weight |
|---|---|---|---|
| Trade Name | Supplier | Description | (solids) |
| Joncryl 624 | Johnson | Styrene Acrylic Copolymer | 69.9 |
| | Polymers | | |
| PVP-K60 | ISP | poly(vinyl pyrrolidone) | 30 |
| BYK 380 | Byk-Chemie | Fluorinated acrylic | 0.1 |

### Example-2

| | | | % Weight |
|---|---|---|---|
| Trade Name | Supplier | Description | (solids) |
| Joncryl | Johnson | Styrene Acrylic Solution | 30 |
| HPD-71 | Polymers | Copolymer (high Tg, high acid#) | |
| Joncryl 624 | Johnson | Styrene Acrylic Emulsion | 39.9 |
| | Polymers | Copolymer (low Tg, low acid#) | |
| BYK 380 | Byk-Chemie | Fluorinated acrylic | 0.1 |
| PVP-K60 | ISP | Polyvinyl Pyrrolidone | 30 |

### Example-3

| | | | % Weight |
|---|---|---|---|
| Trade Name | Supplier | Description | (solids) |
| Joncryl | Johnson | Styrene Acrylic Solution | 29 |
| HPD-71 | Polymers | Copolymer(high Tg, high acid#) | |
| Joncryl 624 | Johnson | Styrene Acrylic Emulsion | 38.9 |
| | Polymers | Copolymer(low Tg, low acid#) | |
| BYK 380 | Byk-Chemie | Fluorinated acrylic | 0.1 |
| PVP-K60 | ISP | poly(vinyl pyrrolidone), PVP | 29 |
| Borax | Spectrum | sodium tetraborate decahydrate | 3.0 |
| | Chemicals | | |

### Example 4

| | | | % Weight |
|---|---|---|---|
| Trade Name | Supplier | Description | (solids) |
| Joncryl | Johnson | Styrene Acrylic Solution | 30 |
| HPD-71 | Polymers | Copolymer (high Tg, high acid#) | |
| Joncryl 624 | Johnson | Styrene Acrylic Emulsion | 39.9 |
| | Polymers | Copolymer (low Tg, low acid#) | |
| BYK 380 | Byk-Chemie | Fluorinated acrylic | 0.1 |
| Mowiol | Kuraray | poly (vinyl alcohol), PVA | 30 |
| 47-88 | | | |

### Example 5

| | | | % Weight |
|---|---|---|---|
| Trade Name | Supplier | Description | (solids) |
| Joncryl | Johnson | Styrene Acrylic Solution | 29 |
| HPD-71 | Polymers | Copolymer(high Tg, high acid#) | |
| Joncryl 624 | Johnson | Styrene Acrylic Emulsion | 38.9 |
| | Polymers | Copolymer(low Tg, low acid#) | |
| BYK 380 | Byk-Chemie | Fluorinated acrylic | 0.1 |
| methocel | Dow | methocel E-15 | 29 |
| E-15 | | | |
| Borax | Spectrum | sodium tetraborate decahydrate | 3.0 |
| | Chemicals | | |

### Example 6

| | | | % Weight |
|---|---|---|---|
| Trade Name | Supplier | Description | (solids) |
| Joncryl | Johnson | Styrene Acrylic Solution | 32.8 |
| HPD-71 | Polymers | Copolymer(high Tg, high acid#) | |
| Joncryl 624 | Johnson | Styrene Acrylic Emulsion | 49.1 |
| | Polymers | Copolymer(low Tg, low acid#) | |
| BYK 380 | Byk-Chemie | Fluorinated acrylic | 0.1 |
| methocel | Dow | methocel E-15 | 15 |
| E-15 | | | |
| Borax | Spectrum | sodium tetraborate decahydrate | 3.0 |
| | Chemicals | | |

### Topcoat Formulations

The following topcoat 16 formulations were prepared and applied over the above-described intercoated samples using a Meyer-rod. The compositions listed are in terms of the dry weight percentages in the finished coating. The coating fluids also contain water, typically at 25%-30% solids, which is taken off in the drying process. In Examples 7 and 8, the alumina is first dispersed in acidic aqueous solution to achieve a dispersion pH of approximately 3.0-4.0. Then the other components are added to make the final topcoat fluids.

### Example 7

| Trade Name | Supplier | Description | % Weight |
|---|---|---|---|
| Poval 235 | Kuraray | Polyvinyl alcohol | 10.3 |
| Dispal 14N4-80 | Sasol | Aluminum hydroxide | 89 |
| | | dispersion | |
| BYK 380 | Byk-Chemie | Fluorinated acrylic | 0.1 |
| Acetic Acid | Aldrich | Organic acid | 0.1 |
| Chemcor 540C25 | Chemcor | PE emulsion | 0.1 |

### Example 8

| Trade Name | Supplier | Description | % Weight |
|---|---|---|---|
| Poval 245 | Kuraray | Polyvinyl alcohol | 6.2 |
| Dispal 14N4-80 | Sasol | Aluminum hydroxide | 93.6 |
| | | dispersion | |
| BYK 380 | Byk-Chemie | Fluorinated acrylic | 0.1 |
| Chemcor 540C25 | Chemcor | PE emulsion | 0.1 |
| Acetic Acid | Aldrich | Organic acid | .1 |

### Comparative Examples of Intercoat Formulations

### Comparative Example 1

In this example, the intercoat consisted of Mowinol 47-88 poly(vinyl alcohol), PVA. It was prepared as an 8% solids aqueous solution.

### Comparative Example 2

In this comparative example, the following intercoat formulation was prepared.

| Chemical | Supplier | Wt % | Description |
|---|---|---|---|
| Poval 245 | Kuraray | 95 | Polyvinyl alcohol |
| Glyoxal | J. T. Baker | 5 | Ethanediol |

### Comparative Example 3

| Chemical | Supplier | Wt % | Description |
|---|---|---|---|
| methocel E-15 | Dow | 96.9 | methocel |
| Borax | Spectrum Chemicals | 3.0 | sodium tetraborate |
| | | | decahydrate |
| BYK 380 | Byk-Chemie | 0.1 | Fluorinated acrylic |

### Examples of Coated Media

In each of the following examples (Examples 9-34), a substrate was selected. It was either topcoated over a substrate with no intercoat, or it was topcoated over a specified dried intercoat. The intercoat layer 14 was dried in a convection oven for 3 minutes at 100° C. Each sample thus had a specified topcoat applied and this was dried under one of the following two conditions:

Topcoat Dry Condition 1: Drying in a convection oven for 3 minutes at 100° C. This condition is used to model slow drying conditions.

Topcoat Dry Condition 2: Drying with a Masterflow Model AH-501 heat blower at 125-130° C. for about 1-2 minutes. This condition is used to model drying in a high capacity drying oven with high heat and air flow.

### Example 9

A piece of Garda 80 lb. clay coated paper was coated at 25 gsm (grams per square meter) with the coating of Example 7 and dried using drying condition 1. Observations of the sample texture were made visually and are presented in Table 1.

### Example 10

A piece of Garda 80 lb. clay coated paper was coated at 25 gsm (grams per square meter) with the coating of Example 7 and dried using drying condition 2. Observations of the sample texture were made visually and are presented in Table 1.

### Example 11

A piece of Garda 80 lb. clay coated paper was coated at 25 gsm (grams per square meter) with the coating of Example 8 and dried using drying condition 1. Observations of the sample texture were made visually and are presented in Table 1.

### Example 12

A piece of Garda 80 lb. clay coated paper was coated at 25 gsm (grams per square meter) with the coating of Example 8 and dried using drying condition 2. Observations of the sample texture were made visually and are presented in Table 1.

### Example 13

A piece of Garda 80 lb. clay coated paper was coated at 8 gsm with the coating of Comparative Example 2 and dried. Then it was coated at 25 gsm with the coating of Example 7 and dried using Drying Condition 1. Observations of the surface texture were made visually and are given in Table 1.

### Example 14

A piece of Garda 80 lb. clay coated paper was coated at 8 gsm with the coating of Comparative Example 2 and dried. Then it was coated at 25 gsm with the coating of Example 7 and dried using Drying Condition 2. Observations of the surface texture were made visually and are given in Table 1.

### Example 15

A piece of Garda 80 lb. clay coated paper was coated at 8 gsm with the coating of Example 1 and dried. Then it was coated at 25 gsm with the coating of Example 7 and dried using Drying Condition 1. Observations of the surface texture were made visually and are given in Table 1.

### Example 16

A piece of Garda 80 lb. clay coated paper was coated at 8 gsm with the coating of Example 1 and dried. Then it was coated at 25 gsm with the coating of Example 7 and dried using Drying Condition 2. Observations of the surface texture were made visually and are given in Table 1.

### Example 17

A piece of Garda 80 lb. clay coated paper was coated at 8 gsm with the coating of Example 2 and dried. Then it was coated at 25 gsm with the coating of Example 7 and dried using Drying Condition 1. Observations of the surface texture were made visually and are given in Table 1.

### Example 18

A piece of Garda 80 lb. clay coated paper was coated at 8 gsm with the coating of Example 2 and dried. Then it was coated at 25 gsm with the coating of Example 7 and dried using Drying Condition 2. Observations of the surface texture were made visually and are given in Table 1.

### Example 19

A piece of Garda 80 lb. clay coated paper was coated at 8 gsm with the coating of Example 3 and dried. Then it was coated at 25 gsm with the coating of Example 7 and dried using Drying Condition 1. Observations of the surface texture were made visually and are given in Table 1.

### Example 20

A piece of Garda 80 lb. clay coated paper was coated at 8 gsm with the coating of Example 3 and dried. Then it was coated at 25 gsm with the coating of Example 7 and dried using Drying Condition 2. Observations of the surface texture were made visually and are given in Table 1.

### Example 21

A piece of Garda 80 lb. clay coated paper was coated at 8 gsm with the coating of Example 3 and dried. Then it was coated at 25 gsm with the coating of Example 8 and dried using Drying Condition 1. Observations of the surface texture were made visually and are given in Table 1.

### Example 22

A piece of Garda 80 lb. clay coated paper was coated at 8 gsm with the coating of Example 3 and dried. Then it was coated at 25 gsm with the coating of Example 8 and dried using Drying Condition 2. Observations of the surface texture were made visually and are given in Table 1.

### Example 23

A piece of 3.8 mil DuPont 565 PET (polyester terephthalate) was coated at 25 gsm (grams per square meter) with the coating of Example 8 and dried using drying condition 1. Observations of the sample texture were made visually and are presented in Table 1.

### Example 24

A piece of 3.8 mil DuPont 565 PET (polyester terephthalate) film was coated at 25 gsm (grams per square meter) with the coating of Example 8 and dried using drying condition 2. Observations of the sample texture were made visually and are presented in Table 1.

### Example 25

A piece of 3.8 mil DuPont 565 PET film was coated with the coating of Comparative Example 1 at 2 gsm and dried. Then it was coated at 25 gsm with the coating of Example 8 and dried using Drying Condition 1. Observations of the surface texture were made visually and are given in Table 1.

### Example 26

A piece of 3.8 mil DuPont 565 PET film was coated with the coating of Comparative Example 1 at 8 gsm and dried. Then it was coated at 25 gsm with the coating of Example 8 and dried using Drying Condition 1. Observations of the surface texture were made visually and are given in Table 1.

### Example 27

A piece of 3.8 mil DuPont 565 PET film was coated with the coating of Example 4 at 8 gsm and dried. Then it was coated at 25 gsm with the coating of Example 7 and dried using Drying Condition 1. Observations of the surface texture were made visually and are given in Table 1.

### Example 28

A piece of 3.8 mil DuPont 565 PET film was coated with the coating of Example 4 at 8 gsm and dried. Then it was coated at 25 gsm with the coating of Example 7 and dried using Drying Condition 2. Observations of the surface texture were made visually and are given in Table 1.

### Example 29

A piece of 3.8 mil DuPont 565 PET film was coated with the coating of Example 2 at 8 gsm and dried. Then it was coated at 25 gsm with the coating of Example 8 and dried using Drying Condition 1. Observations of the surface texture were made visually and are given in Table 1.

### Example 30

A piece of 3.8 mil DuPont 565 PET film was coated with the coating of Example 6 at 8 gsm and dried. Then it was coated at 25 gsm with the coating of Example 8 and dried using Drying Condition 1. Observations of the surface texture were made visually and are given in Table 1.

### Example 31

A piece of 3.8 mil DuPont 565 PET film was coated with the coating of Example 3 at 8 gsm and dried. Then it was coated at 25 gsm with the coating of Example 8 and dried using Drying Condition 1. Observations of the surface texture were made visually and are given in Table 1.

### Example 32

A piece of 3.8 mil DuPont 565 PET film was coated with the coating of Example 3 at 8 gsm and dried. Then it was coated at 25 gsm with the coating of Example 8 and dried using Drying Condition 2. Observations of the surface texture were made visually and are given in Table 1.

### Example 33

A piece of 3.8 mil DuPont 565 PET film was coated with the coating of Example 6 at 8 gsm and dried. Then it was coated at 25 gsm with the coating of Example 8 and dried using Drying Condition 2. Observations of the surface texture were made visually and are given in Table 1.

### Example 34

A piece of 3.8 mil DuPont 565 PET film was coated with the coating of Example 5 at 8 gsm and dried. Then it was coated at 25 gsm with the coating of Example 8 and dried using Drying Condition 2. Observations of the surface texture were made visually and are given in Table 1.

### Example 35

A piece of 3.8 mil DuPont 565 PET film was coated with the coating of Comparative Example 3 at 8 gsm and dried. Then it was coated at 25 gsm with the coating of Example 8 and dried using Drying Condition 2. Observations of the surface texture were made visually and are given in Table 1.

TABLE 1
Observations of the quality of the coated
media prepared in Examples 9-35

| | Coating Quality | Coating Quality |
|---|---|---|
| Media Example | Rating: Splits | Rating: Cracks |
| 9 | 5 | 4 |
| 10 | 2 | 1 |
| 11 | 3 | 3 |
| 12 | 1 | 0 |
| 13 | 3 | 4 |
| 14 | 2 | 2 |
| 15 | 5 | 4 |
| 16 | 5 | 3 |
| 17 | 5 | 5 |
| 18 | 5 | 4 |
| 19 | 5 | 5 |
| 20 | 5 | 5 |
| 21 | 5 | 5 |
| 22 | 5 | 5 |
| 23 | 5 | 0 |
| 24 | 3 | 3 |
| 25 | 0 | 1 |
| 26 | 0 | 1 |
| 27 | 5 | 5 |
| 28 | 5 | 5 |
| 29 | 5 | 3 |
| 30 | 5 | 5 |
| 31 | 5 | 5 |
| 32 | 5 | 5 |
| 33 | 5 | 4 |
| 34 | 5 | 5 |
| 35 | 1 | 1 |

Ratings used in Table 1: The media were evaluated on a relative scale of 0 to 5, where a rating of 5 means the medium has the excellent properties with respect to observable splits or cracks. A rating of 3 or less for cracks is unacceptable. A rating of 4 or less for coating quality for splits is unacceptable.

Media of Examples 18, 20, 22, 28, 32, 33 and 34 are excellent examples of this invention in that they have a rating of 5 for splits, 4 or 5 for cracks, and the topcoat was dried under Drying Condition 2, which provides a process and consequent economic advantage in producing good ink jet media in terms of these properties. These media also yielded excellent images when imaged using an Epson 820 Stylus Photo Printer. The intercoats are supporting intercoats that served to provide stable and absorptive support to the topcoat as it dried under forcing drying conditions.

Moreover, the media produced according to these examples performed well as aqueous-based ink jet media even with microporous topcoats that are thinner than many in the prior art (25 gsm vs. 40 or higher gsm). It is possible to conjecture, without being bound to the theory, that this is due, in part, to the high particle to binder mass ratio that is achievable in the topcoats when the topcoats are placed over the intercoats of this invention and, in part, to the additional absorptive capacity of the mechanically stable supporting intercoat.

By comparison, these topcoats coated over an absorptive but more highly swellable intercoat, such as Comparative Examples 1 and 2, used in media Examples 13, 14, 25 and 26 do not yield acceptable media. Note that these include PVA at 2 gsm and at 8 gsm and crosslinked PVA as intercoats.

Media of Examples 18, 20, 22, 28, 33 and 34 show that the absorptive component of the intercoat of this invention can be PVP, PVA or methocel, at least.

Media of Example 35 may be compared to those of Examples 33 and 34. The comparison shows that the presence of high and low Tg constituents are important to the functioning of one aspect of this invention.

Comparisons of Examples 18 and 29 with 20 and 32, respectively, show the role of borax (borates) when the binder of the microporous topcoat comprises a polymer, such as PVA, that can be gelled or crosslinked by borax.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method for manufacturing a microporous medium for use in inkjet printing comprising a substrate, intercoat and microporous ink receptive topcoat layer with reduced cracking and splitting in the topcoat comprising:
selecting a substrate with a first imaging side and a second back side;
coating and drying onto said first imaging side an aqueous intercoat formed of polymeric material that can absorb water from the microporous ink receptive topcoat layer to reduce splitting and/or cracking of the microporous ink receptive layer;
coating and drying on said dried intercoat an aqueous microporous ink receptive topcoat layer containing inorganic particles and polymeric binder; and
drying the microporous ink receptive topcoat layer by having the intercoat absorb water from the microporous ink receptive topcoat layer while drying water from the top surface of the microporous ink receptive layer.

2. The medium of claim 1, wherein the intercoat comprises: about 20% to about 60% by dry weight of an acrylic copolymer having a glass transition temperature of less than 25.degree. C.; about 10% to about 40% by dry weight of an acrylic copolymer having a glass transition temperature of greater than the drying temperature of the microporous ink receptive topcoat layer; and about 20% of poly(vinyl pyrrolidone).

3. A method for manufacturing a three layer microporous medium comprising a substrate, intercoat and microporous ink receptive topcoat layer with reduced cracking and splitting in the microporous ink receptive layer comprising:
selecting a clay coated paper substrate with a first imaging side and a second side;
coating and drying onto said first imaging side an aqueous intercoat formed of a mixture of sodium tetraborate decahydrate, polymers selected from the group consisting of acrylic polymers, acrylic copolymers PVP, methocel and PEOX that can absorb water from the microporous ink receptive layer to reduce cracking of the microporous ink receptive layer during the drying step for the microporous ink receptive layer in manufacturing of the microporous medium;
coating and on said dried intercoat an aqueous microporous ink receptive topcoat layer containing 80 wt % and 96 wt % and PVA polymeric binder; and
drying on said intercoat the aqueous microporous ink receptive topcoat layer containing 80 wt % and 96 wt % alumina and a PVA polymeric binder by having the intercoat absorb water from the microporous ink receptive topcoat layer while drying water from the top surface of the microporous ink receptive topcoat layer.

4. A method for manufacturing a three layer microporous medium comprising a substrate, intercoat and microporous ink receptive layer with reduced cracking and splitting in the microporous ink receptive layer comprising:
selecting a clay coated paper substrate with a first imaging side and a back side;
coating and drying during a first drying cycle onto said first imaging side an aqueous intercoat formed of a mixture of sodium tetraborate decahydrate, polymers selected as at least two polymers from the group consisting of styrene acrylic polymers having high Tg and high acid function, styrene acrylic copolymers having low Tg and low acid function, PVP, methocel and PVA, and the intercoat can absorb water from the microporous ink receptive layer to reduce cracking of the microporous ink receptive layer during the a second drying cycle for the microporous ink receptive layer during manufacturing of the microporous medium;
coating and on said dried intercoat an aqueous microporous ink receptive topcoat layer containing 80 wt % and 96 wt % and PVA polymeric binder; and
drying on said intercoat the aqueous microporous ink receptive topcoat layer containing 80 wt % and 96 wt % alumina and a PVA polymeric binder by having the intercoat absorb water from the microporous ink receptive topcoat layer while drying water from the top surface of the microporous ink receptive topcoat layer.

5. The method of claim 3 having a styrene acrylic polymer with an a Tg of less 25 and an acid number of 50 and the styrene acrylic copolymer has a Tg of greater than 25 and an acid number of 214.

6. The method of claim 4 wherein the Tg of the styrene acrylic polymer is greater than the temperature of the second drying cycle.

7. The method of claim 2 wherein the intercoat has good mechanical integrity and stability at the temperature of the second drying cycle and absorbs moisture from the top coat during the second drying cycle.

8. The method of claim 2 wherein the absorption of moisture by the intercoat and the surface drying of the top coat provides a controlled dewatering ft the medium during manufacturing.

9. The method of claim 1, wherein the substrate has a back surface.

10. The method of claim 9, further comprising a polymeric curl-controlling coating overlying the back surface of the substrate.

11. The method of claim 1, wherein the substrate is selected from the group comprising: paper substrates, polymer substrates, synthetic fiber substrates, metallic substrates, and composite substrates having a backing sheet and an absorbent coating overlying the backing sheet.

12. The method of claim 1, wherein the supporting intermediate coating comprises an acrylic copolymer having an acid functionality of at least 25.

13. The method of claim 1, wherein the supporting intermediate coating comprises from about 60% to about 90% by dry weight of an acrylic copolymer.

14. The method of claim 13, wherein the supporting intermediate coating further comprises from about 10% to about 40% by dry weight of poly(vinyl pyrrolidone).

15. The method of claim 13, wherein the acrylic copolymer has a glass transition temperature (Tg) less than 25.degree. C.

16. The method of claim 6, wherein the acrylic copolymer has an acid functionality of at least 25.

17. The method of claim 6, wherein the acrylic copolymer is a styrene acrylic.

18. The method of claim 3, wherein the microporous ink receptive layer containing 80 wt % and 96 wt % and PVA polymeric binder coated at 25 gsm and the supporting intermediate coating comprises: about 20% to about 60% by dry weight of an acrylic copolymer having a glass transition temperature of less than 25.degree. C.; about 10% to about 40% by dry weight of an acrylic copolymer having a glass transition temperature of greater than 25.degree. C.; and about 20% of poly(vinyl pyrrolidone).

19. The method of claim 1, wherein said supporting intermediate coating includes a cross-linking agent.

20. The method of claim 1, wherein said microporous ink-receptive coating comprises a dispersion of particles and a polymer resin binder, and wherein said supporting intermediate coating further comprises a cross-linking agent reactive with said polymer resin binder of said microporous ink-receptive coating.

21. The method of claim 1, wherein said cross-linking agent comprises a borate salt.

22. The method of claim 15 wherein the supporting intermediate coating comprises: about 20% to about 60% by dry weight of a polymer or copolymer having a glass transition temperature of less than 25.degree. C.; about 10% to about 40% by dry weight of a polymer or copolymer having a glass transition of greater than 35.degree. C.; and about 5% to about 40% of an absorbent material.

23. The method of claim 15 wherein the supporting intermediate coating comprises: about 20% to about 60% by dry weight of an acrylic polymer or copolymer having a glass transition temperature of less than 25.degree. C.; about 10% to about 40% by dry weight of an acrylic polymer or copolymer having a glass transition of greater than 35.degree. C.; and about 5% to about 40% of an absorbent material selected from the group comprising PVP, PVA, PEOX, and alkylcelluloses.

24. A method according to claim 1 for making a printable medium comprising: a substrate having an imaging surface and a back surface; at least one supporting intermediate coating overlying the imaging surface of the substrate; and at least one microporous ink-receptive coating overlying the at least one supporting intermediate coating, wherein the supporting intermediate coating comprises at least one polymer with a glass transition temperature below 25.degree. C., at least one polymer with a glass transition above 40.degree. C., and at least one absorbent material.

25. The method of claim 18 wherein the supporting intermediate coating comprises: about 20% to about 60% by dry weight of a polymer or copolymer having a glass transition temperature of less than 25.degree. C.; about 10% to about 40% by dry weight of a polymer or copolymer having a glass transition of greater than 35.degree. C.; and about 5% to about 40% of an absorbent material.

26. The method of claim 17 wherein the supporting intermediate coating comprises: about 20% to about 60% by dry weight of an acrylic polymer or copolymer having a glass transition temperature of less than 25.degree. C.; about 10% to about 40% by dry weight of an acrylic polymer or copolymer having a glass transition of greater than 35.degree. C.; and about 5% to about 40% of an absorbent material selected from the group comprising PVP, PVA, PEOX, and alkylcelluloses.
